(19) United States
(12) Patent Application Publication
(10) Pub. No.: US 2026/0318265 A1
(43) Pub. Date: Oct. 15, 2026

(54) LOW-EROSION CASING LINER FOR BURN RATE ENHANCED (BRE) END-BURNING SOLID ROCKET MOTORS (SRMS)

(71) Applicant: Raytheon Company, Arlington, VA (US)

(72) Inventors: Samuel D. Anderson, Tucson, AZ (US); Carl Shanholtz, Fort Ashby, WV (US)

(21) Appl. No.: 19/176,004

(22) Filed: Apr. 10, 2025

(51) Int. Cl. F02K 9/08; F02K 9/95; F23R 3/00

(52) U.S. Cl. CPC F02K 9/08; F02K 9/95; F23R 3/002

(57) ABSTRACT

A burn rate enhanced (BRE) end-burning solid rocket motor (SRM) includes a plurality of BRE wires formed of a transition metal in a solid propellent. Burning of the BRE wires tends to increase an erosion rate of the casing liner and particularly the insulation layer adjacent the BRE wires due to the transition metal acting as a catalyst to decompose the insulation layer. The addition of a sulfur or organosulfur compound to either the insulation layer or bond liner that make up the casing liner poisons the transition metal to deactivate the catalyst at the surface of the casing liner to reduce the erosion rate of the casing liner.

### GOVERNMENT LICENSE RIGHTS

This disclosure was made with government support. The government has certain rights in this invention.

### BACKGROUND

### Field

This disclosure relates to end-burning burn rate enhanced (BRE) solid rocket motors (SRMs).

### Description of the Related Art

An end-burning solid rocket motor (SRM) includes a solid propellent that burns from its aft end forward until all the solid propellent is consumed. This produces hot gasses that are expelled through a nozzle to propel the rocket forward.

As shown in FIGS. 1A-1B and 2A-2B, an end-burning SRM 100 is depicted pre and post initiation. End-burning SRM 100 includes a solid propellent 102 (no axial through hole) within a casing 104 that acts as a combustion chamber and a nozzle 106. End-burning solid propellent 102 may, for example, include ammonium perchlorate (AP), aluminum (Al) Hexanitrohexaazaisowurtzitane (CL-20), Octogen (HMX), Cyclonite (RDX), or other base explosives. The propellant constituents base explosives are mixed with binders, processing aids, combustion stabilizers, and burn rate modifiers to make an energetic material that will burn.

The SRM 100 includes a casing liner 106 between the solid propellent 102 and the casing 104. Casing 104 may be made of steel or a composite material. Casing liner 107 includes an insulation layer 108 and a bond liner 110 that bonds the insulative layer to the surface of solid propellent 102. Insulation layer 108 is a filled elastomeric insulator including a binder polymer such as Ethylene Propylene Diene Monomer rubber (EPDM) or Styrene Butadiene Rubber (SBR) or polyisoprene, fillers such as polyaramid, silicon oxide or clay and various additives.

An ignitor 112 initiates the solid propellent 102 such that that burn front 114 moves axially forward until all the solid propellent 102 is consumed or flight is terminated. This produces hot gasses 116 that are expelled through nozzle 106 to produce thrust that propels the rocket forward.

To increase or control the rate at which the solid propellent 102 burns, one or more burn rate enhancement (BRE) wires 120 are inserted into the solid propellant 102 along or parallel to an axis 122 of the SRM 100. The BRE wires 120 have a higher burn rate than the surrounding solid propellant 102 and create increased surface area of the solid propellent, which increases a rate of gas generation, hence increased thrust as the solid propellent burns. The BRE wires 120 are formed from a transition metal such as found in Groups 3-11 and possibly 12 of the Periodic Table. The wires are typically wound in a helical orientation with the pitch of the winding dictating in part the bulk motor burn rate. Because the wires tend to be quite brittle, the wires are typically would around an inert support structure 124 such as a nylon rod. See US Patent No. 11,008,263 and 11,746,728.

### SUMMARY

The following is a summary that provides a basic understanding of some aspects of the disclosure. This summary is not intended to identify key or critical elements of the disclosure or to delineate the scope of the disclosure. Its sole purpose is to present some concepts of the disclosure in a simplified form as a prelude to the more detailed description and the defining claims that are presented later.

A burn rate enhanced (BRE) end-burning solid rocket motor (SRM) includes a plurality of BRE wires formed of a transition metal in a solid propellent. Burning of the BRE wires tends to increase a peak erosion rate of the casing liner and particularly the insulation layer adjacent the BRE wires due to the transition metal acting as a catalyst to decompose the insulation layer. The addition of a sulfur or organosulfur compound to either the insulation layer or bond liner that make up the casing liner poisons the transition metal to deactivate the catalyst at the surface of the casing liner to reduce the peak erosion rates of the casing liner opposite the BRE wires. The goal is to achieve peak erosion rates that are similar to the peak erosion rates found in a like SRM absent the plurality of BRE wires and the additive.

In an embodiment, an End-Burning Solid Rocket Motor (SRM) includes a casing that acts as a combustion chamber and a solid propellent within the casing, the solid propellent configured to burn from its aft end. An ignitor is positioned aft of the solid propellent to initiate end burning of the solid propellent. A plurality of BRE wires formed of a transition metal are embedded in the solid propellent along or parallel to an axis of the SRM. Each BRE wire is configured to increase a surface area of the solid propellent thereby increasing a rate of gas generation as the solid propellant burns. A casing liner is positioned between the solid propellent and the casing. The casing liner is formed from a filled elastomeric insulator. Burning the BRE wires tends to increase a peak erosion rate of the casing liner opposite the BRE wires due to the transition metal acting as a catalyst to decompose the filled elastomeric insulator. A sulfur or organosulfur compound additive in the casing liner poisons the transition metal to deactivate the catalyst at the surface of the casing liner to reduce the peak erosion rate of the casing liner opposite the BRE wires. The additive poisons the transition metal by chemisorbing sulfur molecules to active sites in the transition metal to physically block molecules from the casing liner from bonding to those active sites. The end-burning of the solid propellent and the erosion of the surface of the casing liner are removed from one another in both time and space such that poisoning of the catalyst has no effect on the end-burning of the solid propellent.

In an embodiment, a normalized peak erosion rate opposite each one of the BRE wires is no more than 20% and preferably no more than 10% greater than a peak erosions rate for the same SRM without the BRE wires and the sulfur or organosulfur compound additive.

In an embodiment, the casing liner includes an insulation layer formed from the filled elastomeric insulator and a bond liner that adheres the insulation layer to the solid propellent. The additive may be included in the insulation layer, the bond liner or both.

In an embodiment, the additive is elemental sulfur. The elemental sulfur is 0.1 to 5 weight percent of the casing liner.

In an embodiment, the additive is an organosulfur compound. The organosulfur compound is 0.1 to 20 weight percent of the casing liner. The organosulfur compound may be one of a sulfide, thioester, thiol, polysulfide, sulfoxide, thiazole and sulfur halide.

In an embodiment, the filled elastomeric insulator includes a binder selected from Ethylene Propylene Diene Monomer rubber (EPDM), Styrene Butadiene Rubber (SBR) and polyisoprene.

In an embodiment, the transition metal is selected from Groups 3-11 of the Periodic Table.

These and other features and advantages of the disclosure will be apparent to those skilled in the art from the following detailed description of preferred embodiments, taken together with the accompanying drawings, in which:

### BRIEF DESCRIPTION OF THE DRAWINGS

FIGS. 1A-1B and 2A-2B, as described above, are sectional views of a typical end-burning BRE enhanced SRM both pre and post initiation of solid propellent burn;

FIGS. 3A-3B illustrate in general how a catalyst functions;

FIG. 4 is a plot of normalized erosion rates of the insulative layer with respect to BRE wire locations around the circumference of the SRM;

FIGS. 5 illustrate the deactivation of the catalyst by including a sulfur or organosulfur compound as an additive to the casing liner;

FIG. 6 is a plot of normalized erosion rates of the insulative layer with respect to BRE wire locations around the circumference of the SRM with and without the sulfur or organosulfer compound additive; and

FIG. 7 is a flow diagram of an embodiment of the fabrication of the casing liner with the sulfur or organosulfer compound additive and the assembly of an end-burn BRE enhanced SRM.

### DETAILED DESCRIPTION

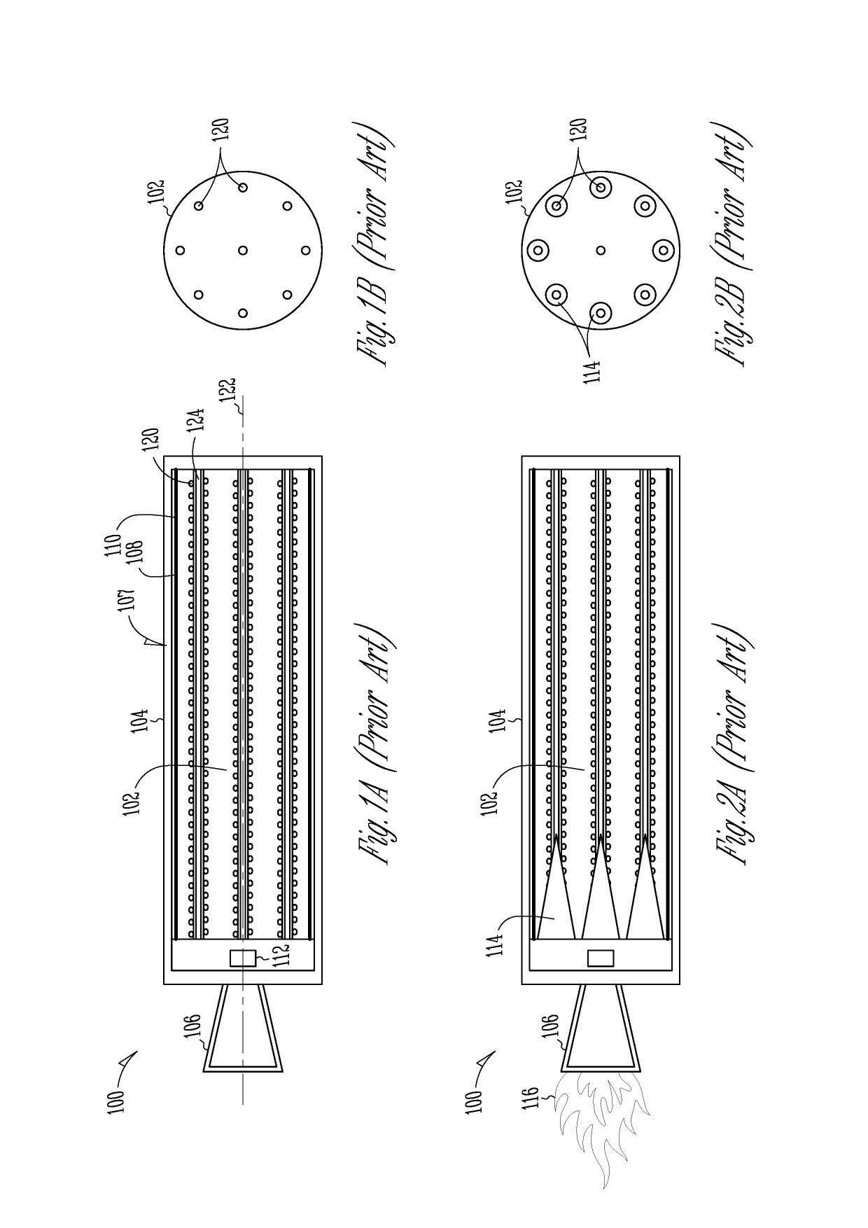

Referring again to FIGS. 1A-1B and 2A-2B, burning of the BRE wires 120 to accelerate end-burning of the solid propellent 102 has the undesired consequence of increasing the erosion rate of the casing liner 107 and particularly the insulation layer 108 adjacent each BRE wire 120. As the BRE wires burn, the molten or gaseous transition metal is carried away with some portion of the metal coming in contact with the inner surface of the casing liner 107. At the surface, the molten or gaseous transition metal acts as a catalyst to decompose the insulation layer 108.

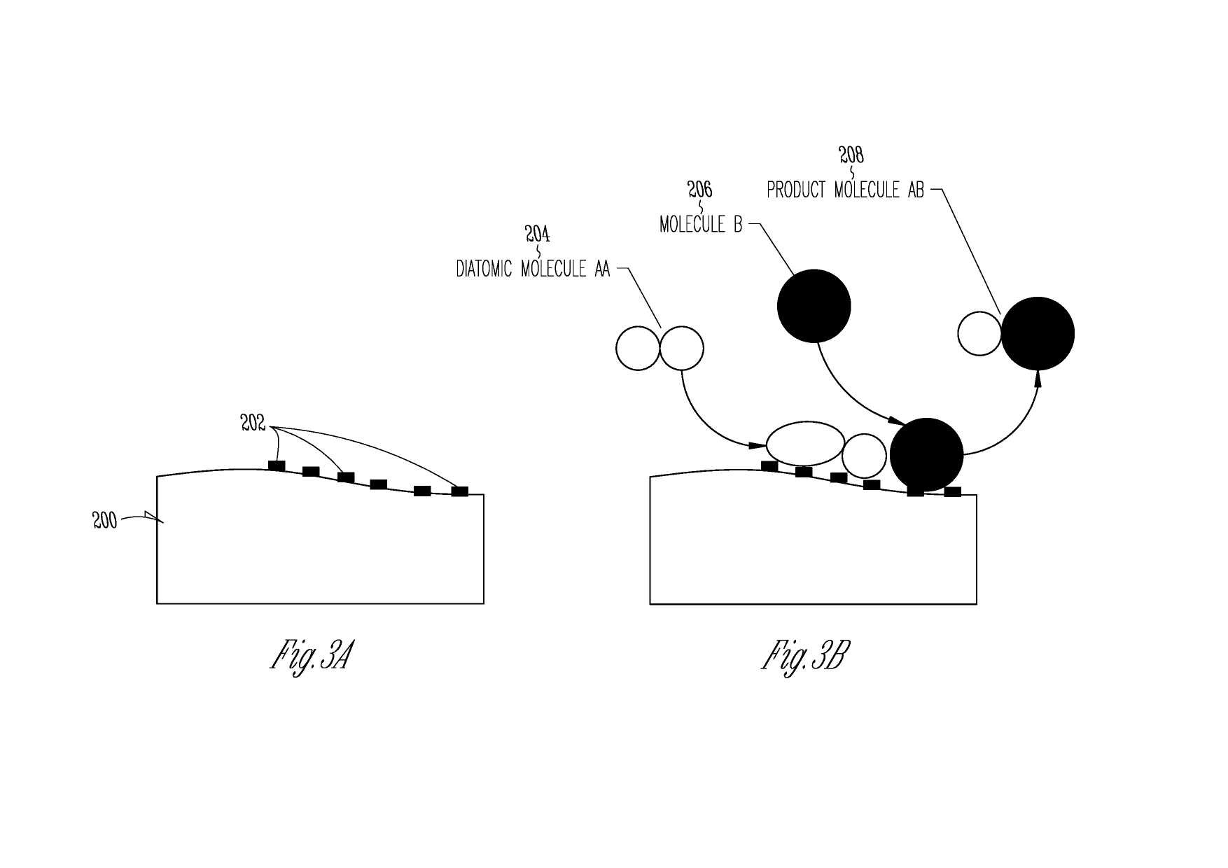

Referring now to FIGS. 3A-3B, a transition metal 200 of the type used in BRE wires has partially filed d-orbitals giving them active sites 202 that attract and bind other molecules. As an illustration of how a catalyst works, a diatomic molecule AA 204 is chemisorbed to generate chemical bonds to active sites 202 of the transition metal. Locations of active sites 202 strain the bond between atoms in molecule AA causing the bond to break. Molecule B 206 is chemisorbed in proximity to molecule AA. The close proximity of molecule B and molecule AA facilitates a reaction in which molecule AB 208 is formed and desorbed to release molecule AB 208 from the surface of the transition metal.

In context of the BRE enhanced end-burning SRM, burning of the BRE wire provides the molten or gaseous transition metal that provides the active sites. The insulation layer individual molecules that are first chemisorbed to the transition metal and then combined and desorbed from the transition metal. This process accelerates the erosion rate of the insulation layer.

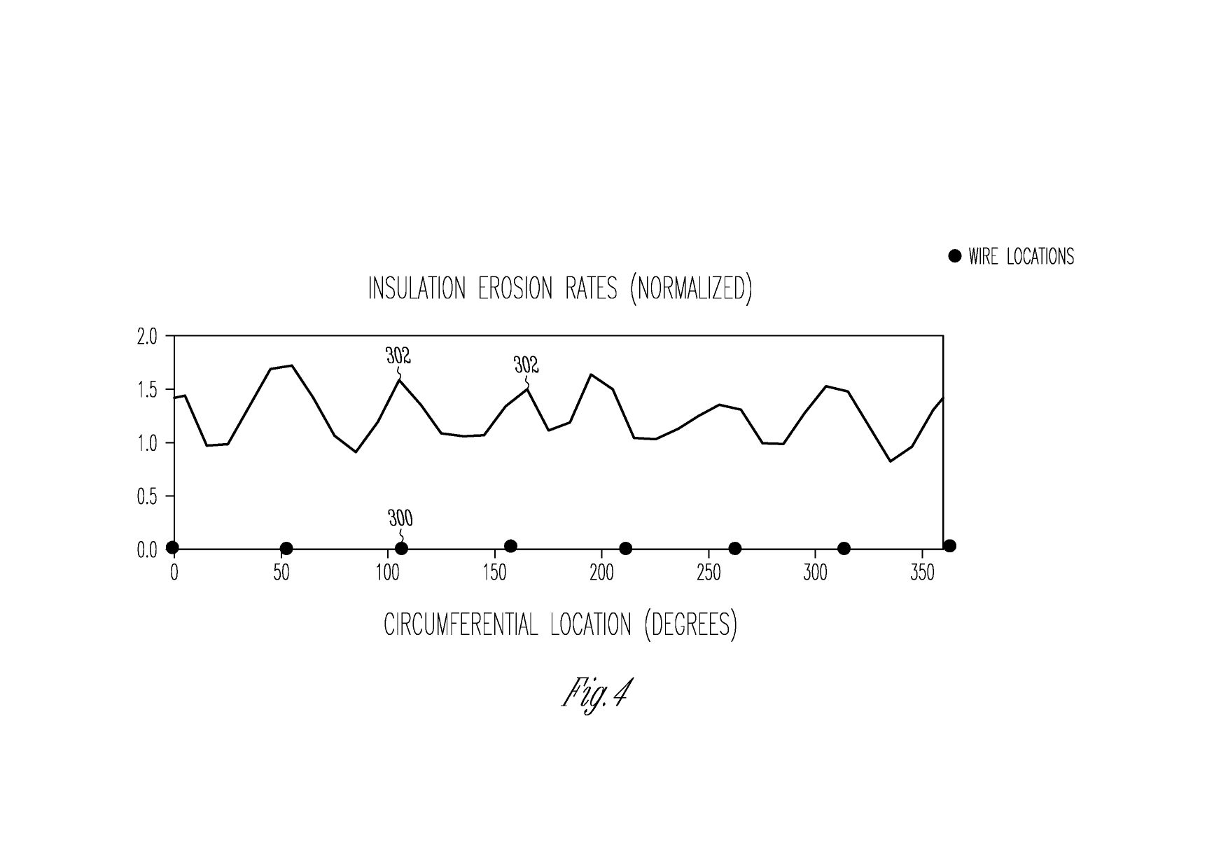

Referring now to FIG. 4, in an embodiment in which 8 BRE wires 300 are located around the circumference of the solid propellent near the casing liner, the normalized insulation rates 302 peak adjacent the BRE wires. The erosion rates are normalized to a like SRM without the BRE wires. As shown, the peak erosions rates at locations opposite the plurality of BRE wires are 50% to 75% greater than the erosion rates not effected by the presence of the BRE wires.

To compensate for the increased insulation rates would require increased thickness of the insulation layer, which reduces the volume of the solid propellent and offsets some of the advantages of using BRE wires.

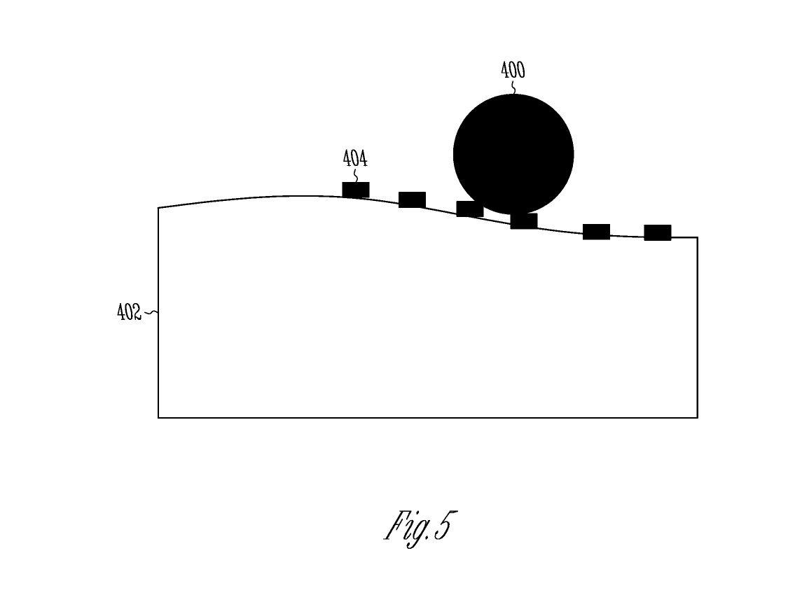

Referring now to FIG. 5, in an embodiment a sulfur or organosulfur compound (e.g., sulfides, thioesters, thiols, polysulfides, sulfoxides, thiazoles and sulfur halides) is added to either the bond liner or insulation layer of the casing liner. A sulfur molecule 400 is very strongly attracted to transition metals 402. When it is chemisorbed, it occupies active sites 404 and physically blocks other molecules from accessing those sites. In the case of reaction to form metal sulfides, the metal sulfides no longer have unfilled d-orbitals available to facilitate other chemical reactions. This process may be referred to as “sulfur poisoning” to deactivate the transition metal catalyst.

In context of the BRE enhanced end-burning SRM, the sulfur or organosulfur additive in the bond liner or insulation layer poisons the transition metal catalyst, which blocks molecules from the insulation layer from chemisorbing to the active sites of the transition metal and then desorbing. This reduces the erosions rate of the insulation layer. The goal being to achieve peak erosion rates that are similar to the peak erosion rates found in a like SRM absent the plurality of BRE wires and the additive.

The amount of the poisoning additive be it sulfur or an organosulfur compound depends on a number of assumptions. If it is assumed that one molecule of sulfur is required to deactivate one molecule of transition metal, and the sulfur is in the bond liner, then approximately 0.4% by weight of sulfur may be required in the bond liner. The one molecule/one molecule assumption is reasonably correct for a gaseous state of the transition metal (catalyst) but high for solid state. Furthermore, one a fraction of the sulfur will actually come into contact with the transition metal due to the dynamic environment inside the SRM. Therefore, 0.1% to 5% by weight of sulfur in the bond liner is a reasonable range. The insulation layer is thicker than the bond liner but more resistant to erosion than the bond line. Therefore the same range of 0.1% to 5% by weight of sulfur in the insulation layer is a reasonable range. For organosulfur compounds the range expands to 0.1% to 20% by weight.

In an alternate illustration of how the catalyst works, a more complex molecule A-B-C chemisorbs to the active sites of the transition metal. Locations of active sites strain the bond between atoms in molecule A-B-C causing the bonds to break to produce separate A-B and C molecules. In the context of the SRM, molecules from the insulation layer chemisorb to the active sites of the transition metal and then break apart, increasing the erosion rate adjacent the BRE wires. The sulfur or organosulfur additives poisons the catalyst and reduces the erosion rate.

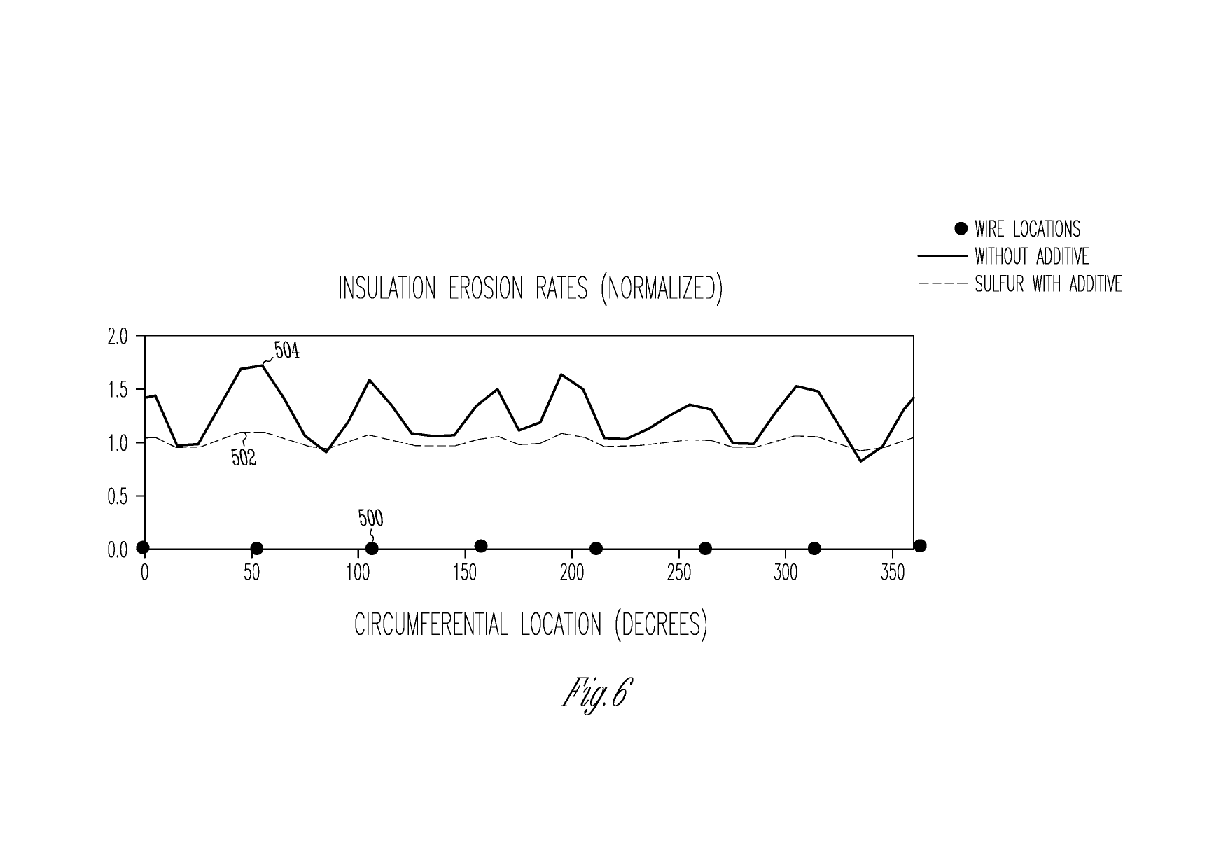

Referring now to FIG. 6, in an embodiment in which 8 BRE wires 500 are located around the circumference of the solid propellent near the casing liner, the normalized insulation rates 502 and 504 with and without the sulfur or organosulfer additive peak adjacent the BRE wires. The erosion rates are normalized to a like SRM without the BRE wires and the sulfur or organosulfur additive. However, the peaks in the erosion rate at locations opposite the BRE wires with the additive are much lower than the peaks without the additive. More particularly, the peaks in the erosion rates with the additive are no more than 20% greater than the erosions rates present in a like SRM without the BRE wires and the additive, and preferably no more than 10% greater. In this case, the thickness of the insulation layer would not need to be thicker, hence maintaining the advantages of the BRE wires to accelerate the burn rate of the solid propellent would be maintained without having to thicken the insulator. This maximizes the volume of the solid propellent and the energy delivered to the SRM.

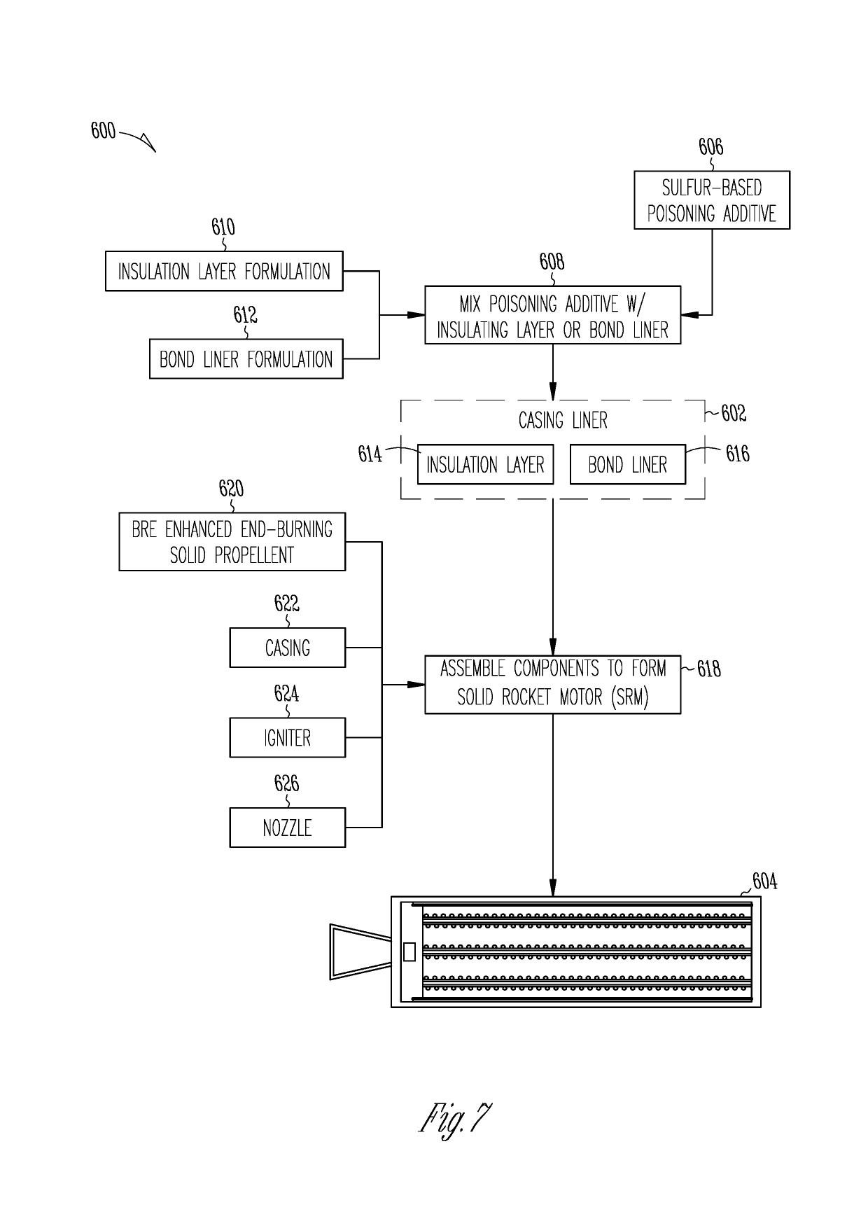

Referring now to FIG. 7, a fabrication and assembly process 600 of an embodiment of a casing liner 602 and a BRE enhanced end-burning SRM 604 starts with a sulfur-based poisoning additive 606 that is mixed 608 with an insulation layer formulation 610 or a bond liner formulation 612 (or both) to form the casing liner 602 including the insulation layer 614 and bond liner 616. The components including the BRE enhanced end-burning solid propellent 620, casing liner 602, casing 622, igniter 624, and nozzle 626 are assembled 618 to form the BRE enhanced end-burning SRM 604. The SRM 604 includes a sufficient amount of a sulfur or organosulfur compound additive in either the insulation layer 614 or bond liner 616 to poison the transition metal of the BRE wires to deactivate the catalyst at the surface of the casing liner 602 to reduce the erosion rate of the casing liner 602.

While several illustrative embodiments of the disclosure have been shown and described, numerous variations and alternate embodiments will occur to those skilled in the art. Such variations and alternate embodiments are contemplated, and can be made without departing from the spirit and scope of the disclosure as defined in the appended claims.

We claim:

1. An end-burning Solid Rocket Motor (SRM), comprises:
a casing that acts as a combustion chamber;
a solid propellent within the casing, said solid propellent configured to burn from its aft end;
an ignitor positioned aft of the solid propellent to initiate end burning of the solid propellent;
a plurality of burn rate enhancement (BRE) wires formed of a transition metal embedded in the solid propellent along or parallel to an axis of the SRM, each said BRE wire configured to increase a surface area of the solid propellent thereby increasing a rate of gas generation as the solid propellant burns;
a casing liner between the solid propellent and the casing, said casing liner formed from a filled elastomeric insulator, wherein burning of the BRE wires tends to increase a peak erosion rate of the casing liner opposite the BRE wires due to the transition metal acting as a catalyst to decompose the filled elastomeric insulator; and
a sulfur or organosulfur compound additive to the casing liner that poisons the transition metal to deactivate the catalyst at the surface of the casing liner to reduce the peak erosion rate of the casing liner opposite the BRE wires.

2. The end-burning SRM of claim 1, wherein a normalized peak erosion rate adjacent each one of the BRE wires is less than 20% greater than a peak erosion rate for the same SRM without the plurality of BRE wires and the sulfur or organosulfur compound additive.

3. The end-burning SRM of claim 1, wherein a normalized peak erosion rate adjacent each one of the BRE wires is less than 10% greater than a peak erosion rate for the same SRM without the plurality of BRE wires and the sulfur or organosulfur compound additive.

4. The end-burning SRM of claim 1, wherein the casing liner includes an insulation layer formed from the filled elastomeric insulator and a bond liner that adheres the insulation layer to the solid propellent.

5. The end-burning SRM of claim 4, wherein the sulfur or organosulfur compound additive is added to the insulation layer.

6. The end-burning SRM of claim 4, wherein the sulfur or organosulfur compound additive is added to the bond liner.

7. The end-burning SRM of claim 1, wherein the additive is elemental sulfur.

8. The end-burning SRM of claim 7, wherein the elemental sulfur is 0.1 to 5 weight percent of the casing liner.

9. The end-burning SRM of claim 1, wherein the additive is an organosulfur compound.

10. The end-burning SRM of claim 9, wherein the organosulfur compound is 0.1 to 20 weight percent of the casing liner.

11. The end-burning SRM of claim 9, wherein the organosulfur compound is one of a sulfide, thioester, thiol, polysulfide, sulfoxide, thiazole and sulfur halide.

12. The end-burning SRM of claim 1, wherein the end-burning of the solid propellent and the erosion of the surface of the casing liner are removed from one another in both time and space such that poisoning of the catalyst has no effect on the end-burning of the solid propellent.

13. The end-burning SRM of claim 1, wherein the sulfur or organosulfur compound additive poisons the transition metal by chemisorbing sulfur molecules to active sites in the transition metal to physically block molecules from the casing liner from bonding to those active sites.

14. A casing liner for use with a burn rate enhanced (BRE) end-burning Solid Rocket Motor (SRM) that includes a plurality of BRE wires formed from a transition metal and embedded in solid propellent within a casing, the casing liner comprises:
an insulation layer formed of a filled thermoelastic insulator, said insulation layer configured to fit over the solid propellent;
a bond liner on an inner surface of the insulation layer, said bond liner configured to adhere the insulation layer to the solid propellent; and
a sulfur or organosulfur compound additive to the casing liner that poisons the transition metal to deactivate a catalyst at the surface of the casing liner to reduce a peak erosion rate of the casing liner.

15. The end-burning SRM of claim 14, wherein the casing liner includes an insulation layer formed from the filled elastomeric insulator and a bond liner that adheres the insulation layer to the solid propellent.

16. The end-burning SRM of claim 15, wherein the sulfur or organosulfur compound additive is added to the insulation layer or the bond liner.

17. The end-burning SRM of claim 14, wherein the additive is elemental sulfur.

18. The end-burning SRM of claim 14, wherein the elemental sulfur is 0.1 to 5 weight percent of the casing liner.

19. The end-burning SRM of claim 14, wherein the additive is an organosulfur compound.

20. The end-burning SRM of claim 19, wherein the organosulfur compound is 0.1 to 20 weight percent of the casing liner.
